(19) United States
(12) Patent Application Publication
(10) Pub. No.: US 2009/0058103 A1
(43) Pub. Date: Mar. 5, 2009

(54) OVER-CENTER DRAW LATCHES WITH SELF-ALIGNMENT FEATURES

(76) Inventor: James C. Whitney, Norwalk, CT (US)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/850,259

(22) Filed: Sep. 5, 2007

(51) Int. Cl. E05C 19/14

(52) U.S. Cl. 292/247

(57) ABSTRACT

A spring loaded over-center draw latch is provided having a latch bail that exerts an upward force on the mating parts when the latch is closed. The latch includes self-alignment feature attached to the latch body, which prevents misalignment of the mating parts when the latch is closed.

### BACKGROUND OF THE INVENTION

1. Field of the Invention

This disclosure relates generally to over-center draw latches. More particularly, the present disclosure is related to over-center draw latches with self-alignment features.

2. Description of the Related Art

Many types of over-center draw latches are generally known in the art. These over-center draw latches, when in a latched condition, provide positive over-center latching, normally by means of strong spring action. Unfortunately, such latches have not proven effective when connecting one or more flexible or deformable members to one another. Here, it is common for the strong latch spring forces to deflect the flexible members to a significant degree, thereby causing misalignment of the latch and its bail receiving member, preventing the desired over-center toggle action.

For example, vacuum collection, mulching, and transportation devices for material such as soil and lawn debris such as, but not limited to, leaves, sticks, rocks, lawn trimmings, and the like (hereinafter “debris”) have been developed. Collection devices collect debris in a collector unit or bagger (hereinafter “collector unit”) that utilize sections of semi-rigid tubing or conduit that direct the debris toward the collector unit.

The tubing sections act as the conduit through which debris is transported to the collector unit. Multiple tubing or conduit sections are often joined to one another depending on the positioning of the collector unit relative to the vacuum intake.

It has been determined by the present disclosure that when using over-center draw latches to hold the tubing sections together, the latch can cause the tubing sections to deform or bend. In some instances, the deformation of the tubing sections can lead to pressure loss caused by a deformed tube or duct that cannot seal properly. In other instances, the deformation of the tubing sections can result in the latch moving out of the over-center position, causing the latch to fail in its over-center toggle action and thereby releasing the tubing sections from one another.

Accordingly, there is a need for over-center draw latches that overcome, alleviate, and/or mitigate one or more of the aforementioned and other deleterious effects of the prior art.

### SUMMARY

An over-center draw latch is provided that prevents misalignment of mating support parts.

An over-center draw latch is provided. The latch includes a spring loaded bail member pivotally received on a latch base, a bail receiving member configured to releasably receive the bail member, and a self-alignment feature. The self-alignment feature has a portion that extends beyond the base towards the bail receiving member.

A latch system is also provided that includes a first support member, a second support member, a spring-loaded over center bail member, a bail receiving member, and a self-alignment feature. The spring-loaded over center bail member is disposed on the first support member. The bail receiving member is disposed on the second support member opposite the bail member. The bail receiving member is configured to releaseably receive the bail member. The self-alignment feature is disposed under the bail member and extends beyond the first support member so that a portion of the self-alignment feature rests on the second support member.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a side view of a prior art over-center draw latch in an open position;

FIG. 2 is a side view of the over-center draw latch of FIG. 1 in a closed and misaligned position;

FIG. 3 is a side view of an exemplary embodiment of an over-center draw latch according to the present disclosure in an open position;

FIG. 4 is a side view of the over-center draw latch of FIG. 3 in a closed and aligned position;

FIG. 5 is another side view of the latch of FIG. 3;

FIG. 6 is a bottom view of the latch in FIG. 5;

FIG. 7 is a cross-sectional view of the latch in FIG. 3, taken generally along line 7-7 in FIG. 6;

FIG. 8 is a perspective view of the self-alignment member shown in FIG. 5;

FIG. 9 is a side view of the self-alignment member shown in FIG. 8;

FIG. 10 is a perspective view of an alternative embodiment of the self-alignment member shown in FIG. 8;

FIG. 11 is a side view of the self-alignment member shown in FIG. 10;

FIG. 12 is a perspective view of the latch shown in FIGS. 3 and 5 shown joining a fixture to a flexible duct;

FIG. 13 is a cross-sectional view of the latch and ducts shown in FIG. 12, taken generally along line 13-13;

FIG. 14 is a perspective view of an over-center draw latch having an alternate embodiment of a self-alignment feature according to the present disclosure;

FIG. 15 is a side view of the over-center draw latch of FIG. 14 in an open position; and

FIG. 16 is a side view of the over-center draw latch of FIG. 14 in a closed open position.

### DETAILED DESCRIPTION OF THE PREFERRED EMBODIMENTS

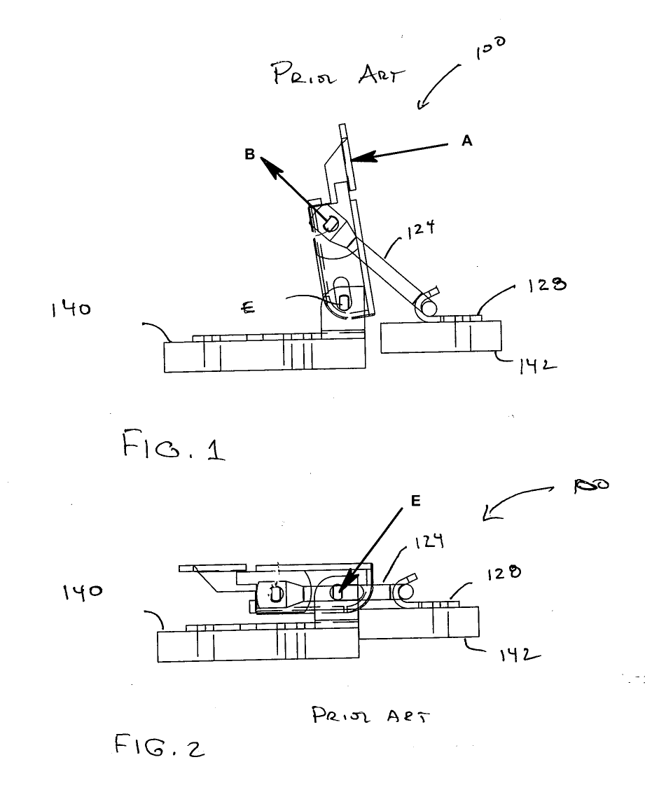

Referring to the drawings, and in particular to FIGS. 1 and 2, which are side views of prior art over-center draw latches 100 illustrating a problematic misalignment condition discovered by the present disclosure. Latch 100 includes a bail member 124 and a bail receiving member 128. Bail member 124 is secured on a first support member 140, while bail receiving member 128 is secured on a second support member 142. Latch 100 is closed by application of a closing force in the direction of arrow A.

In response to the closing force, latch 100 includes one or more internal springs (not shown) that generate a latching force in the direction of arrow B. Thus, bail member 124 transmits the latching force B to bail receiving member 128, which pulls up on second support member 142.

In some instances, latch 100 can be used on devices where first and/or second support members 140, 142 are flexible such that latching force B deflects or deforms second support member 142 upward and out of alignment with first support member 140.

It has been determined by the present disclosure that the misalignment of first and second support members 140, 142 negatively effects the ability of latch 100 to remain closed.

For example and as shown in FIG. 2, when latch 100 is in its closed position, bail member 124 has not reached an over-center position such that the latch can easily spring open. As used herein, the over-center position is defined as the point where bail member 124 is below a center point or toggle axis E of latch 100. In FIG. 2, bail member 124 is substantially co-planar to center point E such that the latch 100 is not considered to be in its over-center position. When latch 100 is not in its over-center position, the latch can easily spring open.

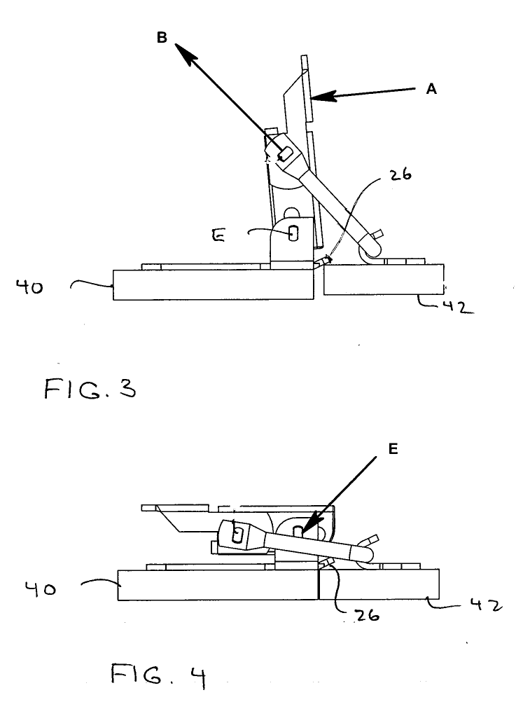

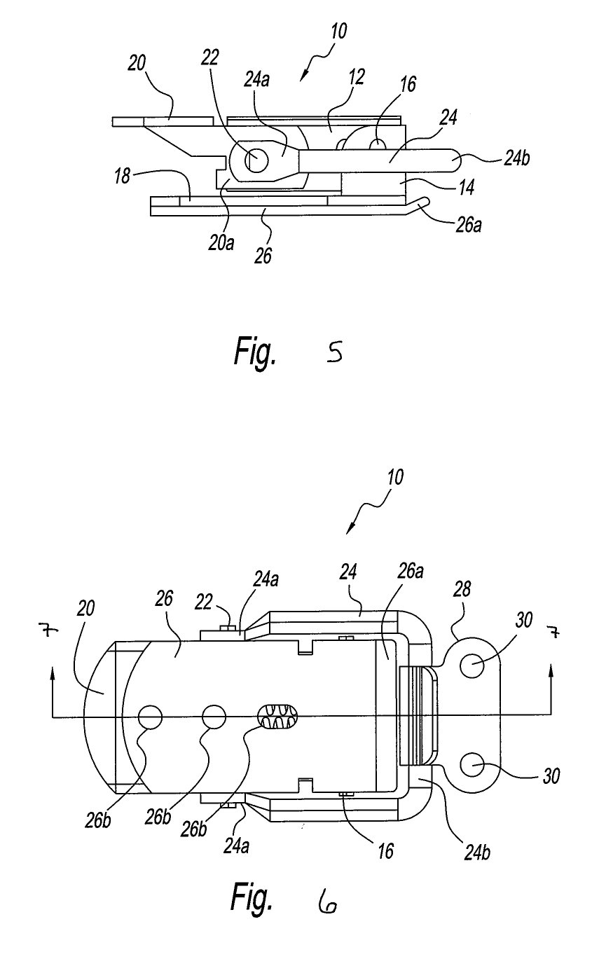

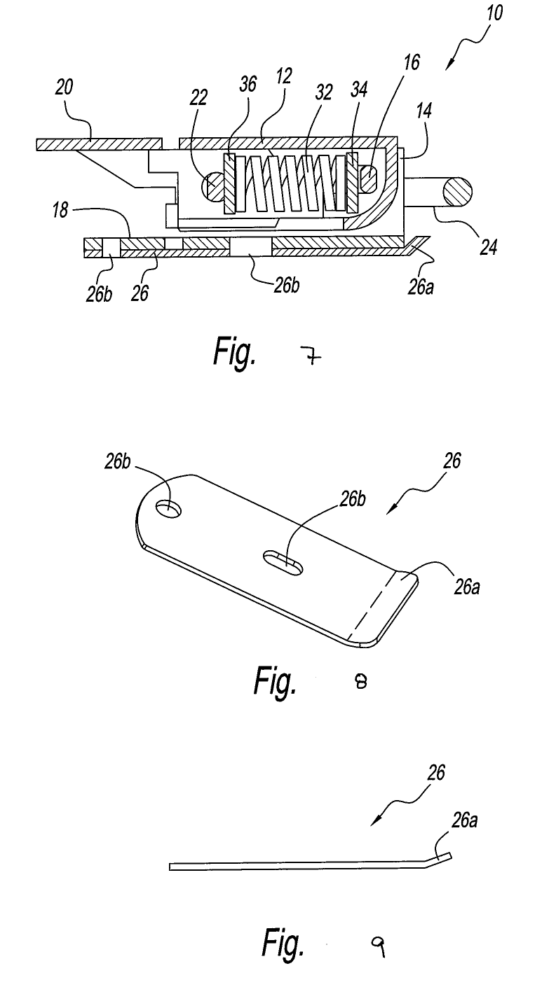

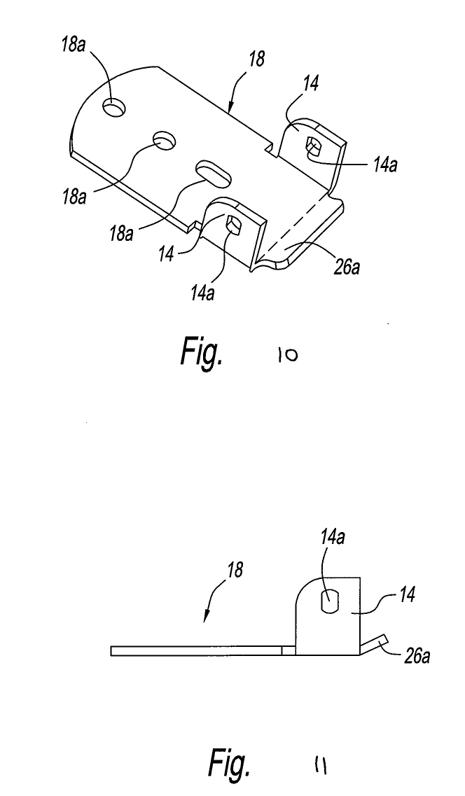

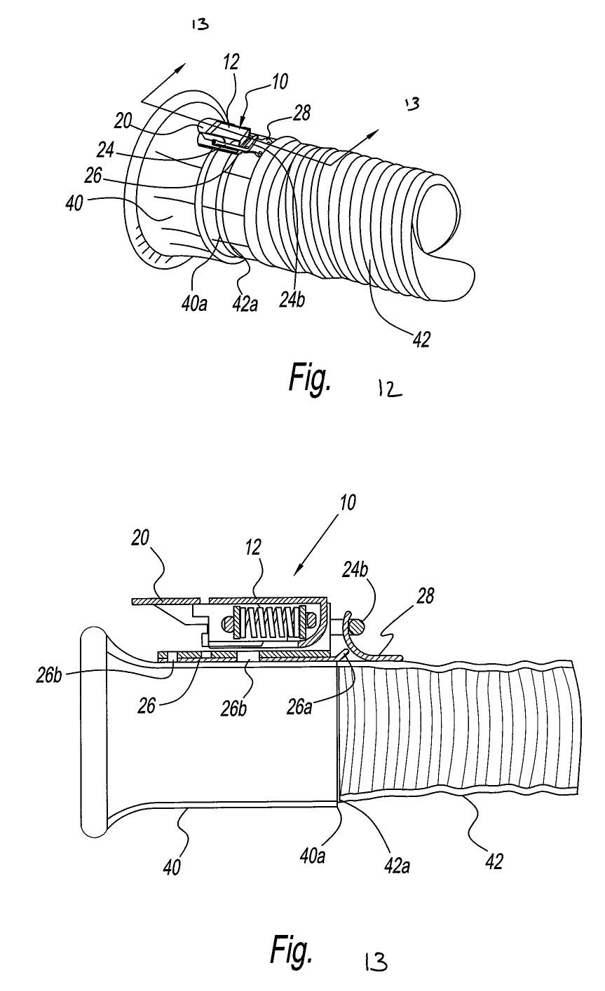

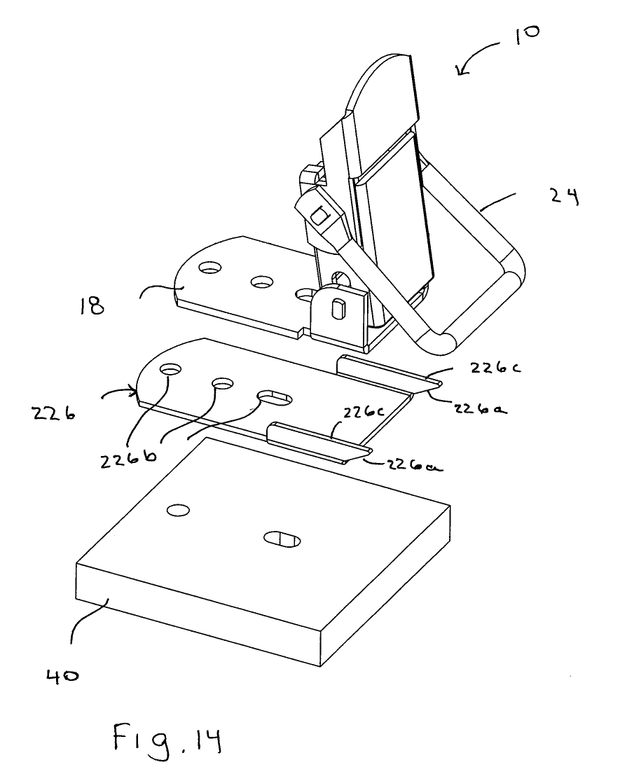

Referring now to the drawings, and in particular to FIGS. 3 and 4, which is a side view of an exemplary embodiment of an over-center draw latch 10 according to the present disclosure.

Advantageously, latch 10 includes a self-alignment feature 26 that, in use, have been determined by the present disclosure to alleviate the misalignment that can result in the first and second support members 40, 42 that the latch is joining together. In this manner, self-alignment feature 26 is configured to maintain latch 10 in its over-center or locked position so that the latch is suitable for use with rigid, semi-rigid, and flexible support members, including, but not limited to tubes and/or conduits.

Latch 10 includes a bail member 24 and a bail receiving member 28. Bail member 24 is secured on first support member 40, while bail receiving member 28 is secured on second support member 42. Latch 10 is closed by application of a closing force in the direction of arrow A. In response to the closing force, latch 10 includes one or more internal springs (not shown) that generate a latching force in the direction of arrow B. Thus, bail member 24 transmits the latching force B to bail receiving member 28, which pulls up on second support member 42.

Self-alignment feature 26 extends below latch 10 from first supporting member 40 towards second supporting member 42. In this position, a least a portion of self-alignment feature 26 rests on an upper surface of second supporting member 42. In the event that latch 10 is used on devices where first and/or second support members 40, 42 are flexible, self-alignment feature 26 prevents latching force B from deflecting or deforming second support member 42 upward and out of alignment with first support member 40.

Thus, it has been determined by the present disclosure that the misalignment of first and second support members 40, 42 can be prevented by self-alignment feature 26.

For example and as shown in FIG. 4, when latch 10 is in its closed position, bail member 24 has reached an over-center position such that the latch can not easily spring open. More specifically, bail member 24 is below the center point E of latch 10 such that the latch is in its over center position and remains latched.

Latch 10 can be used to join any support members to one another. For example, the support members can include sections of ductwork, tubing, or conduit (see FIG. 8) or a housing or fixture. However, latch 10 can also be used to join an assortment of support members such as but not limited to conduits, upper and lower sections of hinged luggage, or boxes and containers. Latch 10 can also be used to join support members that are rigid, semi-rigid, flexible or have flexible portions that can be deformed.

For purposes of clarity, an exemplary embodiment of latch 10 is described with respect to FIGS. 5 through 12. Latch 10 has a housing 12 to which a bracket 14 is attached on each side with a pin 16 that runs through the housing 12 and each side of the bracket 14. Pin 16 is shaped and positioned to enable housing 12 to pivot upon bracket 14 at the pin. Each end of pin 16 can be peened to prevent the pin 16 from becoming unattached or loosened from brackets 14 and housing 12. Bracket 14 has an integral base 18 that enables latch 10 to be attached to a base support member.

Attached opposite the insertion point of pin 16 on housing 12 is a lever 20, which is pivotally secured to housing 12 by a second pin 22 that runs through housing 12 and flanges 20a on each side of the lever 20. Second pin 22 is positioned and shaped to enable lever 20 to pivot about the second pin 22 while remaining secured to housing 12.

Bail member 24 is also pivotally connected to housing 12 by second pin 22 at bail member parts 24a on both sides of housing 12. Second pin 22 can also be peened at each end to prevent the second pin 22 from loosening or becoming unattached from bail member parts 24a and flanges 20a.

Bail member 24 is shown attached to housing 12 atop flanges 20a of lever 20. However, it should be appreciated that other arrangements are possible, including, but not limited to bail member parts 24a being arranged between flanges 20a and housing 12. Thus, second pin 22 enables both lever 20 and bail member 24 to pivot independently.

In some embodiments as shown in FIGS. 1 through 5, self-alignment feature 26 is attached to base 18 of latch 10. In other embodiments as shown in FIGS. 6 and 7, self-alignment feature 26 is combined with or integral to base 18.

In some embodiments and as best seen in the side view of latch 10 shown in FIG. 5, it is evident that self-alignment feature 26 is shown to have a upturned lip 26a at one end of latch 10 proximate the end of latch 10 that pin 16 is inserted.

FIG. 5 shows latch 10 in the latched position. In the latched position, bail member 24 is below pin 16 at the center of the latch, or is at a slight angle down toward base 18, which is referred to as the over-center position. If bail member 24 approaches a position that is above pin 16 or generally parallel with base 18, the spring tension in latch 10 begins to force bail member 24 from a latched position to an unlatched position.

In the illustrated embodiment, tension within latch 10 is provided by a spring(s) 32 that hold the latch 10 closed with the bail member 24 in the over-center position to prevent latch 10 from opening. Of course, it is contemplated by the present disclosure for latch 10 to be provided with the necessary spring force in a number of different ways. For example, bail member 24 itself can be an elastic member configured to provide the necessary spring force. In other embodiment, spring 32 can be a leaf spring or any other elastically deformable spring member.

FIG. 6 shows a bottom view of latch 10 with bail receiving member 28. In some aspects, bail receiving member 28 is attached to a second support member by inserting an attachment device, such as a screw or similar device, through apertures 30. Bail receiving member 28 can be attached using numerous other known attachment methods as well. Part 24b of bail member 24 latches inside of or is received by bail receiving member 28 when latch 10 is secured in the latched position.

Latch 10 and self-alignment feature 26 can be attached to a support member using screws or another fastening device attached through apertures 26b. Other known attachment methods can be used to attach self-alignment feature 26 as well. In some embodiments, bail receiving member 28 and latch 10 are attached to different pieces that are to be joined by latch 10. In this respect bail receiving member 28 and latch 10 are positioned to enable the arrangement shown in FIGS. 6, 12, and 13.

FIG. 7 is a cross-sectional view of latch 10, taken generally along line 7-7 in FIG. 6. This view shows housing 12 having a compartment the houses springs 32 along a longitudinal direction. The springs 32 are bounded in the compartment, on each side by plates, 34 and 36. Although this cross-sectional view shows a single spring 32, in some embodiments latch 10 has two or more springs 32 aligned parallel to each other. However, in other embodiments as many springs as desired can be used. Furthermore, other latch designs may incorporate springs external to the latch body, as well as springs which may be tension, torsion, compression or leaf springs. Also, some latch designs may use bail 24 itself as a spring member, the flexure of which provides spring tension for the latch.

Plates 34 and 36, positioned on opposite ends of housing 12, are held in place by pins 16 and 22, respectively, as well as the force exerted by spring or springs 32. More precisely, pin 16 is positioned adjacent plate 34, along the length of plate 34, opposite spring 32. The compressive force exerted by spring 32 pushes against plate 34, however, pin 16 prevents plate 34 from moving past pin 16.

Pin 22 accomplishes the same task on the opposite end of housing 12 by preventing plate 36 from moving past pin 22 as the compressive force exerted by spring 32 pushes plate 36 against pin 22.

This cross-sectional view, in FIG. 7 also shows that in some embodiments, pins 16 and 22 have flat sides with rounded ends. This configuration enables the rotation of pins 16 and 22 to apply uniform resistance of the movement of plates 34 and 36 as springs 32 force plates 34 and 36 outward, however, the rounded ends of pins 16 and 22 enable the pins to rotate. This pin configuration also enables the individual pieces connected by the pins, i.e., housing 12, lever 20, and bail member 24, to pivot. In some embodiments, pins 16 and 22 rotate simultaneously with the rotation of housing 12, lever 20, or bail member 24. The apertures in housing 12, lever 20, and bail member 24 are configured with flat ends that the flat sides of pins 16 and 22 abut. In this configuration rotation of the housing 12 or bail member 24 will result in pins 16 and 22 rotating as well.

In this embodiment where pins 16 and 22 have flat sides, the rotation of pin 16 with housing 12, or pin 22 with bail member 24 will result in pins 16 and 22 engaging plates 34 and 36. This engagement with plates 34 and 36 provides resistance that resists the rotation of housing 12 and bail member 24.

In FIGS. 5 through 7, latch 10 is shown in the latched position. To open latch 10 lever 20 is lifted away from base 18, leading to the release of housing 12 from a latched position. As lever 20 is lifted progressively further, housing 12 is pivoted about pin 16 with the upward movement of lever 20, until bail member 24 is sufficiently loose to enable it to be pivoted from bail receiving member 28.

To fasten latch 10, segment 24b of bail member 24 is hooked around bail receiving member 28, while housing 12 is in an upward pivoted position. In this upward position, housing 12 relieves pressure of the spring 32 on bail member 24, which enables it to be positioned around bail receiving member 28. After positioning bail member 24, lever 20 is pivoted downward toward base 18, which causes housing 12 to pivot downward. Latch 10 is secured in the latched position, as bail member 24 is positioned in its over-center position.

As shown in FIGS. 8 and 9, in some embodiments, self-alignment feature 26 is attached under latch 10 on a conduit. Self-alignment feature 26 is arranged so that lip 26a is positioned proximate the end of latch 10 that pin 16 is inserted into, i.e., proximate bail member part 24b. Lip 26a is oriented and shaped to clear an abutting support member 42 that bail receiving member 28 is positioned on. Thus, lip 26a acts as a cam surface during closing of latch 10 to ensure that first and second support members 40, 42 are aligned with one another. Self-alignment feature 26 can also include apertures 26b that can align with similar apertures on base 18 for attaching purposes.

In the embodiment shown in FIGS. 10 and 11, lip 26a is combined with or integral with base 18. Just as base 18 has brackets 14 attached to base 18 that are used to pivotally secure housing 12, the combination base 18 and lip 26a has brackets 14 that can be used to pivotally secure housing 12 thereto. Pin 16, or similar elements, can also be used by inserting it through apertures 14a in brackets 14 and through similar sized and shaped apertures in housing 12, as described for the embodiment shown in FIGS. 5 through 7. Fastening devices, such as screws, rivets, etc. can be inserted through apertures 18a to attach latch 10 to another surface. Additionally, an adhesive or another known fastening means can be used to attach latch 10.

FIG. 12 shows a first support member 40 joined to a second support member 42 using latch 10. For purposes of clarity, first and second support members 40, 42 are illustrated by way of example as conduits for use in a vacuum system. However, it should be appreciated that any support members can be joined together by latch 10. It has been determined by the present disclosure that latch 10 finds particular use where first and/or second support members 40, 42 have a tendency to bow or deform under the pressure exerted by the latch 10.

The resistance provided by latch 10, via springs 32, enables latch 10 to securely join support member 40 to support member 42. The tension generated by spring(s) 32 enables latch 10 to hold first and second support members together. However, that same tension tends to deform one or both of the support members that are being held together. The deformation caused by the spring-loaded power of latch 10 can lead to buckling or bending of the support members held together by the latch. Even a portion of support member 40 or support member 42, even if it is rigid, can be deformed.

Deleterious effects caused by the deformation and tension in latch 10, include the unintended unlatching of latch 10. Unintended unlatching can occur when bail member 24 begins to pitch upward and cross over the center of toggle axis E of FIG. 2. As discussed above, latch 10 is designed to remain in its latched position when bail member 24 is in the over-center position. Deformation of support member 40 and/or support member 42 can cause bail member 24 to pivot to a point past center point E, placing latch 10 in a position that is prone to unintentional unlatching.

Deformation of the support members that latch 10 is fastened is one of the leading causes for unintentional unlatching. The bending upward of edge 42a of support member 42, which is caused by tension from latch 10 drawing support members 40 and 42 together.

To avoid the deleterious drawbacks of using spring-loaded latches such as latch 10, self-alignment feature 26 has been provided by the present disclosure to alleviate the deformation and stress that can be subjected upon the first and second support members 40, 42 being joined by latch 10.

As discussed above, latch 10 has a tendency to pitch upward at the junction between support members 40 and 42 due to the force generated by latch 10 and the deformation of support members 40 and/or 42. Movement and shaking, which may occur at the junction between the support members 40 and 42, can exacerbate this deflection of latch 10. The lip 26a on self-alignment feature 26 creates a stop that prevents or limits upward deflection of edge 42a. Thus, lip 26a can prevent or at least mitigate the amount of deflection that occurs because lip 26a bridges support members 40 and 42 limiting the amount of deflection. As forces attempting to deflect edge 42a upward, lip 26a abuts edge 42a and prevents the deflection. Thus, lip 26a essentially links support members 40 and 42, which tends to provide a stronger junction between the support members 40 and 42.

In the cross-sectional view in FIG. 13, taken generally along line 13-13 in FIG. 12, self-alignment feature 26 extends over edge 42a of support member 42. This arrangement enables self-alignment feature 26 to alleviate stress that would normally be exerted upon edge 42a of adjoining support member 42 as a latch, identical or similar to latch 10, is latched.

In the arrangement shown in FIGS. 12 and 13 the end of base 18 that is proximate bail member part 24b is laterally aligned with the edge 40a of support member 40. This is a typical attachment point of latch 10. Self-alignment feature 26 and more importantly lip 26a is positioned to overhang edge 42a of second support member 42.

In some embodiments, self-alignment feature 26 can be substituted by a base 18 incorporating lip 26a, as shown in FIGS. 10 and 11. Base 18, as shown in FIGS. 10 and 11, prevents deformation of support members and resists the buckling of edge 40a and/or 42a, or support members 40, 42, which is caused by pressure exerted by latch 10. Thus, the self-alignment feature 26 and base combination shown in FIGS. 10 and 11, with lip 26a, functions similarly to self-alignment feature 26.

All parts of latch 10, self-alignment feature 26 and the other various parts herein described are best manufactured from steel or another metallic alloy that has a high tensile strength and rigidity. However, another material other than metal, which can provide rigidity and strength, can be used to manufacture latch and the associated parts described.

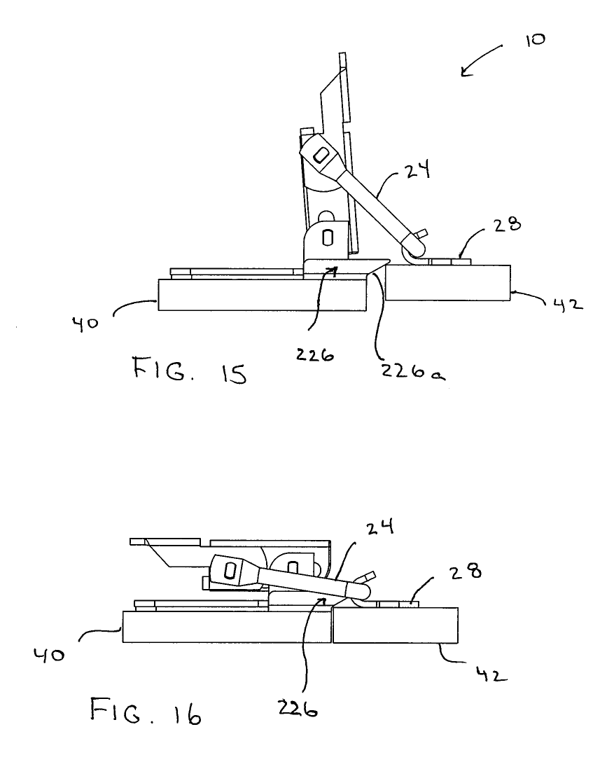

It should be recognized that self-alignment feature 26 is described herein having lip 26a by way of example only. Of course, it is contemplated by the present disclosure for self-alignment feature 26 to have any shape necessary to prevent misalignment of the first and second support members 40, 42 due to deformation. For example, an alternate exemplary embodiment of a self-alignment feature according to the present disclosure illustrated in FIGS. 14-16 is shown by way of reference numeral 226.

In this embodiment, self-alignment feature 226 includes a pair of upstanding edges 226c each having a cam surface 226a defined thereon. Thus, cam surface 226a of edges 226c ensure that first and second support members 40, 42 are aligned with one another during closing of latch 10.

Self-alignment feature 226 can also include apertures 226b that can align with similar apertures on base 18 and supporting member 40 for attaching purposes

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. An over-center draw latch, comprising:
a spring loaded bail member pivotally received on a latch base;
a bail receiving member configured to releasably receive said bail member; and
a self-alignment feature having a portion that extends beyond said base towards said bail receiving member.

2. The over-center draw latch of claim 1, wherein said bail member is a rigid bail member, the latch further comprising a spring configured to provide a spring force to said rigid bail member.

3. The over-center draw latch of claim 3, wherein said spring is selected from the group consisting of a tension spring, a torsion spring, a compression spring, a leaf spring, and any combinations thereof.

4. The over-center draw latch of claim 1, wherein said bail member is a flexible bail member configured to provide a spring force to the latch.

5. The over-center draw latch of claim 1, wherein said portion comprises a lip having a bend that is arranged at an angle to provide a cam surface.

6. The over-center draw latch of claim 1, wherein said portion comprises pair of upstanding edges each having a cam surface.

7. The over-center draw latch of claim 1, wherein said self-alignment feature is integral to said latch base.

8. The over-center draw latch of claim 1, wherein said self-alignment feature is secured to said latch base.

9. A latch system comprising:
a first support member;
a second support member;
a spring-loaded over-center bail member disposed on said first support member;
a bail receiving member disposed on said second support member opposite said bail member, said bail receiving member being configured to releaseably receive said bail member; and
a self-alignment feature disposed under said bail member, said self-alignment feature extending beyond said first support member so that a portion of said self-alignment feature rests on said second support member.

10. The latch system of claim 9, wherein said spring-loaded over-center bail member is a rigid bail member, the latch further comprising a spring configured to provide a spring force to said rigid bail member.

11. The latch system of claim 10, wherein said spring is selected from the group consisting of a tension spring, a torsion spring, a compression spring, a leaf spring, and any combinations thereof.

12. The latch system of claim 9, wherein said spring-loaded over-center bail member is a flexible bail member configured to provide a spring force to the latch system.

13. The system of claim 9, wherein said portion comprises a lip having a bend that is arranged at an angle to provide a cam surface.

14. The system of claim 9, further comprising a latch base, said spring-loaded over center bail member being rotatably affixed to said latch base.

15. The system of claim 14, wherein said self-alignment feature is integral to said latch base.

16. The system of claim 14, wherein said self-alignment feature is secured to said latch base.
